(19) United States
(12) Patent Application Publication
(10) Pub. No.: US 2013/0252115 A1
(43) Pub. Date: Sep. 26, 2013

(54) POWER GENERATION SYSTEM USING PLASMA GASIFIER

(71) Applicants: Yong Cheol Hong, Daejeon (KR); Dong Hun Shin, Daejeon (KR); Bong Ju Lee, Daejeon (KR); Han Sup Uhm, Daejeon (KR); Sang Ju Lee, Daejeon (KR); Hyeong Won Jeon, Daejeon (KR)

(72) Inventors: Yong Cheol Hong, Daejeon (KR); Dong Hun Shin, Daejeon (KR); Bong Ju Lee, Daejeon (KR); Han Sup Uhm, Daejeon (KR); Sang Ju Lee, Daejeon (KR); Hyeong Won Jeon, Daejeon (KR)

(73) Assignee: KOREA BASIC SCIENCE INSTITUTE, Daejeon (KR)

(21) Appl. No.: 13/990,835

(22) PCT Filed: Dec. 3, 2010
(86) PCT No.: PCT/KR2010/008633

§ 371 Date: May 31, 2013

(30) Foreign Application Priority Data
Dec. 1, 2010 (KR) 10-2010-0121234

(51) Int. Cl. H01M 8/06; F01K 13/00; F02B 43/08

(52) U.S. Cl. CPC H01M 8/0643; F02B 43/08; H01M 8/0675; F01K 13/00
USPC 429/410; 123/3; 60/643

(57) ABSTRACT

A generation system using a plasma gasifier, includes a plasma gasifier that combusts pulverized coal or biomass using plasma so as to generate a synthesis gas including hydrogen (H₂) and carbon monoxide (CO), an impurity removing device that removes an impurity included in the generated synthesis gas, a gas storage tank in which the synthesis gas, an impurity of which has been removed by the impurity removing device, is stored, and a gas engine that combusts the synthesis gas stored in the gas storage tank so as to produce electricity.

### TECHNICAL FIELD

The present invention relates to a hydrocarbon gasification combined generation system including coal or biomass.

### BACKGROUND ART

An integrated gasification combined cycle (IGCC) means generation in which coal is converted into a synthesis gas, main constituents of which are hydrogen (H₂) and carbon monoxide (CO), and then electricity is generated using the synthesis gas.

The largest advantage of using an IGCC is that generation can be performed using a coal resource that is widely spread worldwide and has rich deposits. In addition, the IGCC has high thermal efficiency and thus can reduce the generation quantities of carbon dioxide (CO₂), sulfur oxides, nitrogen oxides, and dust per unit generation electric power quantity and has been evaluated as technology having very excellent environmental performance. In addition, the IGCC has been spotlighted as technology of future generation that can be applied to carbon dioxide (CO₂) separation storage technology, hydrogen production technology, and a system associated with fuel cells.

FIG. 9 is a conceptual view of the IGCC. As illustrated in FIG. 9, in an IGCC system, first, coal is combusted to generate a synthesis gas, and the generated synthesis gas is injected into a gas turbine to produce electric power. Also, a steam turbine operates by heat of an exhaust gas discharged from the gas turbine so that electric power can be produced again. Also, the synthesis gas is not used only in generation, but liquefied fuels, such as diesel, gasoline, and dimethyl ether (DME) and chemicals, such as methanol and ethylene, can be produced from the synthesis gas using coal liquefaction technology, and hydrogen can also be produced from the synthesis gas.

In this way, the IGCC has advantages in relation to efficiency and environmental pollution in comparison with thermal power generation using coal according to the related art and can be combined with various fields. However, the IGCC according to the related art has the following problems.

First, in the IGCC according to the related art, coal is gasified by radiant heat of a high temperature furnace in a gasification process of coal, and thus preheating of 1,300° C. to 1,500° C. is required to operate a gasifier. Thus, much time and high cost for preheating the gasifier are required.

Also, since the IGCC according to the related art requires a high pressure of more than 25 atmospheric pressure for gasification, it is very difficult to miniaturize the gasifier and it is also difficult to control the gasifier.

Also, an oxygen generation facility cost required for pure oxygen gasification is 15% of the entire construction cost, and thus high cost for an oxygen generation facility is required.

### DISCLOSURE

### Technical Problem

The present invention is directed to providing a generation system in which, in a generation system for an integrated gasification combined cycle (IGCC), a synthesis gas is produced using a plasma gasifier so that, even when low-quality coal having a high ash content is used, generation can be performed and a 1 atmospheric pressure process is adopted to produce electric power at a low cost.

More preferably, the present invention is directed to providing coal gasification having a high ratio of H₂/CO composition using pure steam plasma.

### Technical Solution

One aspect of the present invention provides a generation system including: a plasma gasifier that combusts pulverized coal or biomass using plasma so as to generate a synthesis gas including hydrogen (H₂) and carbon monoxide (CO); an impurity removing device that removes an impurity included in the generated synthesis gas; a gas storage tank in which the synthesis gas, an impurity of which has been removed by the impurity removing device, is stored; and a gas engine that combusts the synthesis gas stored in the gas storage tank so as to produce electricity.

Another aspect of the present invention provides a generation system including: a plasma gasifier that combusts pulverized coal or biomass using plasma so as to generate a synthesis gas including hydrogen (H₂) and carbon monoxide (CO); an impurity removing device that removes an impurity included in the generated synthesis gas; a gas storage tank in which the synthesis gas, an impurity of which has been removed by the impurity removing device, is stored; and a solid oxide fuel cell (SOFC) that produces electricity using the synthesis gas stored in the gas storage tank.

### Advantageous Effects

According to exemplary embodiments of the present invention, even when low-quality coal having high ash constituents (ash constituents of more than 45%) is used, a synthesis gas can be produced using a gasifier using plasma so that the usage range of coal for generation can be increased.

In addition, according to exemplary embodiments of the present invention, since the synthesis gas is produced in a 1 atmospheric pressure environment, a generation facility can be miniaturized, and the generation facility can be constructed at a low cost. Since a 1 atmospheric pressure process is used, generation can be performed using not a gas turbine but a gas engine or a solid oxide fuel cell (SOFC).

In addition, according to the present invention, even when not coal but biomass is used, gasification can be performed so that the present invention is advantageous in technology and device aspects in comparison with a generation method according to the related art.

### BRIEF DESCRIPTION OF DRAWINGS

FIG. 1 illustrates a generation system 100 using a plasma gasifier according to a first exemplary embodiment of the present invention.

FIG. 2 illustrates a generation system 200 using a plasma gasifier according to a second exemplary embodiment of the present invention.

FIG. 3 is a block diagram of a plasma generator 300 according to an exemplary embodiment of the present invention.

FIG. 4 is a graph showing an optical emission spectrum obtained from an electromagnetic wave plasma torch using only pure steam (H₂O).

FIGS. 5A and 5B are longitudinal cross-sectional views illustrating a portion in which a waveguide 310 and a discharge tube 312 are connected to each other, of the plasma generator 300 illustrated in FIG. 3.

FIGS. 6A through 6C are latitudinal cross-sectional views illustrating a detailed configuration of a gas supply unit 314 of the plasma generator 300 of FIG. 3.

FIGS. 7A and 7B are latitudinal cross-sectional views illustrating a detailed configuration of a coal supply unit 316 of the plasma generator 300 of FIG. 3.

FIGS. 8A and 8B are views illustrating a plasma gasifier 102 including at least one plasma generator 300, according to exemplary embodiments of the present invention.

FIG. 9 is a conceptual view of an integrated gasification combined cycle (IGCC) system according to the related art.

### MODES OF THE INVENTION

Hereinafter, exemplary embodiments of the present invention will be described in detail. However, the present invention is not limited to the exemplary embodiments disclosed below, but can be implemented in various forms.

In the description of the present invention, if it is determined that a detailed description of a known technology related to the invention may unnecessarily obscure the subject matter of the invention, the detailed description will be omitted. In addition, the following terms are terms that are defined in consideration of functions in the present invention and may vary according to user's and operator's intentions or practices. Thus, their definitions should be based on contents throughout the present specification.

A technical spirit of the present invention is determined by the claims, and the following embodiments are just a means of efficiently describing the technical spirit of the present invention to one of ordinary skill in the art.

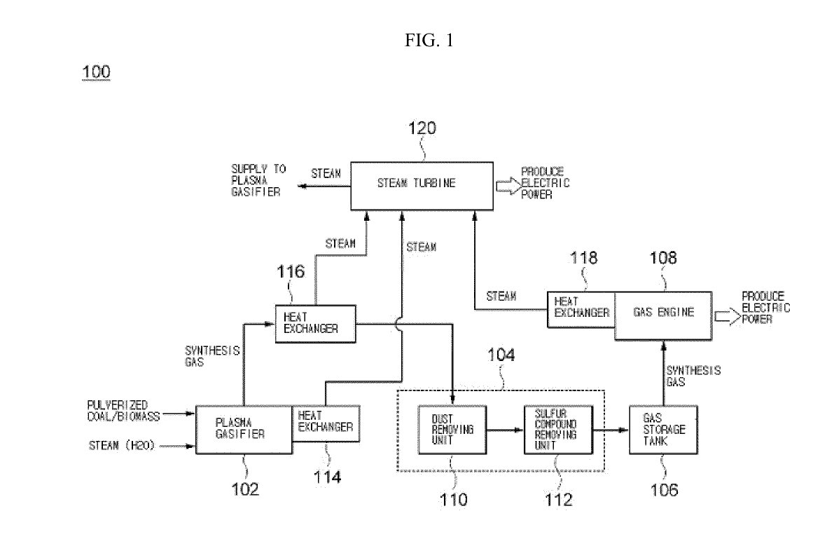

FIG. 1 illustrates a generation system 100 using a plasma gasifier according to a first exemplary embodiment of the present invention.

As illustrated in FIG. 1, the generation system 100 using the plasma gasifier according to the first exemplary embodiment of the present invention includes a plasma gasifier 102, an impurity removing device 104, a gas storage tank 106, and a gas engine 108.

The plasma gasifier 102 is a device that generates a synthesis gas including hydrogen (H₂) and carbon monoxide (CO) from pulverized coal or biomass using plasma. A detailed configuration of the plasma gasifier 102 will be described below.

The impurity removing device 104 removes an impurity included in the synthesis gas generated by the plasma gasifier 102. The impurity removing device 104 may include a dust removing unit 110 and a sulfur compound removing unit 112, as illustrated in FIG. 1. The dust removing unit 110 removes dust, such as ash included in the synthesis gas generated by the plasma gasifier 102. Also, the sulfur compound removing unit 112 removes sulfur compounds included in the synthesis gas. Detailed configurations of the dust removing unit 110 and the sulfur compound removing unit 112 and a method of removing dust and sulfur compounds using them are well known to the present technical field, and thus detailed descriptions thereof will be omitted. Also, the impurity removing device 104 may be configured to include other units for removing the impurity included in the synthesis gas in addition to the dust removing unit 110 and the sulfur compound removing unit 112.

The gas storage tank 106 is a space in which the synthesis gas, an impurity of which, such as dust or sulfur compounds, has been removed by the impurity removing device 104, is stored. The synthesis gas with a predetermined quantity may be stored in advance in the gas storage tank 106 so as to be used in an initial operation of the generation system 100 illustrated in FIG. 1. Thus, the gas engine 108 produces electricity by combusting the synthesis gas that has been stored in advance in the gas storage tank 106 when the initial operation of the generation system 100 is performed, and operates the plasma gasifier 102 using part of produced electricity so that the entire generation system 100 according to the first exemplary embodiment of the present invention can operate.

The gas engine 108 produces electricity by combusting the synthesis gas stored in the gas storage tank 106. An integrated gasification combined cycle (IGCC) according to the related art is configured to produce electricity using a gas turbine; however, the current embodiment of the present invention is configured to produce a synthesis gas using an 1 atmospheric pressure process and thus is configured to produce electricity by driving the gas engine 108 (not the gas turbine) using the synthesis gas. In this way, when the synthesis gas is produced using the plasma gasifier 102 and the gas engine 108 is driven using the synthesis gas, gas production and electric power production are performed under a 1 atmospheric pressure so that miniaturization can be realized in comparison with the IGCC according to the related art.

An operation of the generation system 100 using the plasma gasifier having the above configuration according to the first exemplary embodiment of the present invention in an energy aspect will now be described below.

First, when general mass constituent ratios of carbon and combustible hydrocarbon included in coal (pulverized coal) that is a raw material are

C:H₂:O₂=70%:7%:23%,

if the mass constituent ratios are converted into molar ratios,

C:H₂:O₂=5.83:3.5:1.44,

if the molar ratio of carbon is converted into 1,

C:H₂:O₂=1:0.6:0.25.

Meanwhile, enthalpy, H, which is required for decomposition of hydrocarbon in which oxygen and hydrogen are contained, is defined by the following equation: H=40 kJ. In this case, hydrocarbon is assumed as compounds, such as polymer hydrocarbon and methanol.

A reaction between carbon and hydrocarbon included in coal inside a plasma torch in the plasma gasifier 102 is as follows:

C+(¼)O₂+(0.6)H₂+(½)H₂O→CO+(1.1)H₂

In this case, enthalpy change is defined by the following equation: ΔH=10.4 kJ.

Meanwhile, a combustion reaction inside the gas engine 108 is

CO+(1.1)H₂+(1.05)O₂→CO₂+(1.1)H₂O,

and enthalpy change in this combustion reaction is defined by the following equation: ΔH=−549 kJ.

If an electric power production efficiency of the gas engine 108 is about 32%, electric power production quantity per 1 mole of carbon is defined by the following equation: 549 kJ×0.32=175.7 kJ. In this case, required electric energy is defined by the following equation: 40+10.4=50.4 kJ. Thus, pure electric power production quantity is defined by the following equation: 175.7−50.4=125.3 kJ.

Meanwhile, the generation system 100 using the plasma gasifier according to the first exemplary embodiment of the present invention may further include the plasma gasifier 102, heat exchangers 114, 116, and 118 that convert the synthesis gas produced by the plasma gasifier 102 or heat generated from the gas engine 108 into steam, and a steam turbine 120 that produces electricity using the steam generated by the heat exchangers 114, 116, and 118. In this way, heat generated in the generation system 100 is converted into electricity using the steam turbine 120 so that efficiency of the generation system 100 can be improved.

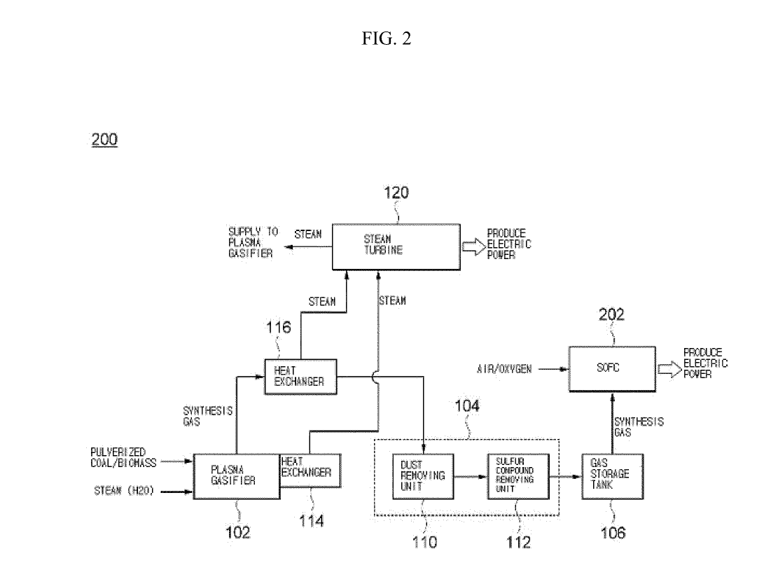

FIG. 2 illustrates a generation system 200 using a plasma gasifier according to a second exemplary embodiment of the present invention.

As illustrated in FIG. 2, the generation system 200 using the plasma gasifier according to the second exemplary embodiment of the present invention includes a plasma gasifier 102, an impurity removing device 104, a gas storage tank 106, and a solid oxide fuel cell (SOFC) 202.

Among them, the plasma gasifier 102, the impurity removing device 104, and the gas storage tank 106 illustrated with the same reference numerals as those of FIG. 1 perform the same functions as those of the first embodiment and thus detailed descriptions thereof will be omitted.

In the present embodiment, unlike the first embodiment, electric power is produced using the SOFC 202. The SOFC 202 is a device that converts chemical energy into electric energy using a hydrocarbon fuel, has a very high energy conversion efficiency, has high stability, and is easy to handle, because it uses a solid. In the IGCC according to the related art, a process is performed under a high pressure and thus the usage of an SOFC is not possible. However, in the present embodiment, like in the above-described first embodiment, since a process is performed under a 1 atmospheric pressure, generation using the SOFC 202 can be performed.

Meanwhile, the generation system 200 using the plasma gasifier according to the second exemplary embodiment of the present invention may further include the plasma gasifier 102, heat exchangers 114 and 116 that convert heat generated from a synthesis gas produced by the plasma gasifier 102 into steam, and a steam turbine 120 that produces electricity using the steam generated by the heat exchangers 114 and 116, like in the first embodiment. In this way, heat generated in the generation system 200 is converted into electricity using the steam turbine 120 so that efficiency of the generation system 100 can be improved.

Also, even in the present embodiment, like in the first embodiment, at an initial stage, the SOFC 202 is driven using the synthesis gas stored in the gas storage tank 106 to produce initial electric power, and the plasma gasifier 102 is driven using the produced electric power so that the entire system can operate.

Hereinafter, the plasma gasifier used in the first embodiment and the second embodiment of the present invention will be described. The plasma gasifier 102 used in the first and second embodiments of the present invention includes at least one plasma generator 300 and a gasification reactor 800 in which the synthesis gas is generated by plasma generated by the plasma generator 300.

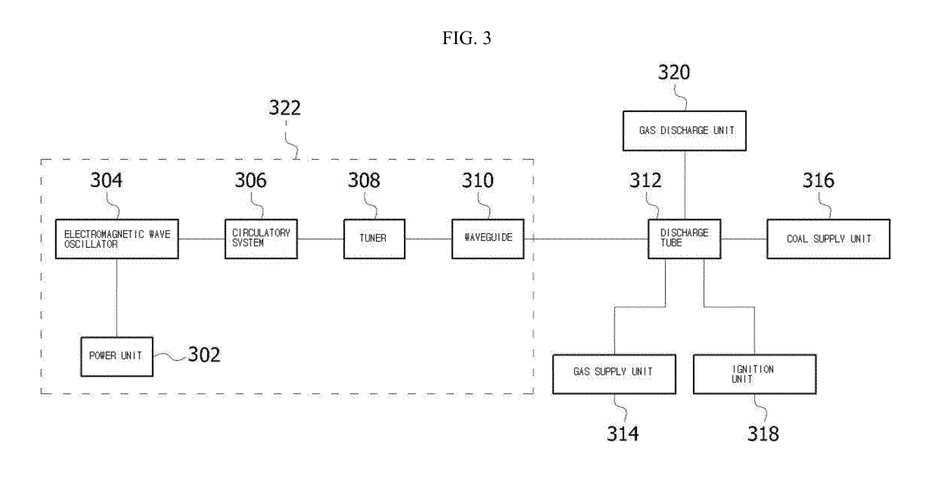

FIG. 3 is a block diagram of a plasma generator 300 according to an exemplary embodiment of the present invention.

As illustrated in FIG. 3, the plasma generator 300 includes a power unit 302, an electromagnetic wave oscillator 304, a circulatory system 306, a tuner 308, a waveguide 310, a discharge tube 312, a gas supply unit 314, a coal supply unit 316, an ignition unit 318, and a gas discharge unit 320.

The power unit 302 supplies electric power required to drive the plasma generator 300.

The electromagnetic wave oscillator 304 is connected to the power unit 302 and oscillates electromagnetic waves by receiving electric power from the power unit 302. An electromagnetic wave oscillator that oscillates electromagnetic waves having a frequency range of 902 to 928 MHz or 886 to 896 MHz is used in the present invention, and preferably, electromagnetic waves having a frequency of 915 MHz or 896 MHz are oscillated using the electromagnetic wave oscillator 304.

The circulatory system 306 is connected to the electromagnetic wave oscillator 304, outputs the electromagnetic waves oscillated by the electromagnetic wave oscillator 304 and simultaneously, dissipates electromagnetic wave energy that is reflected with impedance mismatch so as to protect the electromagnetic wave oscillator 304.

The tuner 308 induces impedance matching by adjusting intensities of incident waves and reflected waves of the electromagnetic waves output from the circulatory system 306 such that an electric field induced by the electromagnetic waves is the maximum in the discharge tube 312.

The waveguide 310 transmits the electromagnetic waves input from the tuner 308 to the discharge tube 312. In the present invention, the size of the waveguide 310 has a relation with the frequency of the electromagnetic waves oscillated by the electromagnetic wave oscillator 304. If the frequency of the electromagnetic waves oscillated by the electromagnetic wave oscillator 304 decreases, the wavelength of the electromagnetic waves increases. Thus, when electromagnetic waves having different frequencies are introduced into a waveguide having a predetermined size, electromagnetic waves having a lower frequency than a cutoff frequency of the waveguide are not introduced into the waveguide. That is, the waveguide serves as a kind of high pass filter. Thus, the size of the waveguide is determined depending on a used frequency.

The cutoff frequency of the waveguide is defined by the following equation 1:

$$\begin{matrix}Equation 1 & \\ {f}_{c} = {\frac{c}{2 π} [ {( m π / a )}^{2} + {( n π / b )}^{2} ]}^{1 / 2} , & ( 1 )\end{matrix}$$

where f_{c} is a cutoff frequency, c is the velocity of light, a is a latitudinal size of a waveguide, b is a longitudinal size of the waveguide, and m and n are electromagnetic wave mode numbers in the waveguide.

In the present invention, a waveguide with the latitudinal size a of 25 cm*the longitudinal size b of 12.5 cm is used. Also, in the present invention, the electromagnetic waves are oscillated in a TE₁₀ mode. Thus, in this case, m is 1, and n is 0. The cutoff frequency of the waveguide 310 according to the present invention is calculated by the following equation 2:

$$\begin{matrix}Equation 2 & \\ {f}_{c , 10} = \frac{c}{2 a} = \frac{3 \times {10}^{10} cm \text{/} s}{( 2 \times 25 cm )} = 0.6 GHz . & ( 2 )\end{matrix}$$

As described above, the electromagnetic wave oscillator 304 according to the present invention oscillates the electromagnetic waves having the frequency range of 902 to 928 MHz or 886 to 896 MHz. Thus, the frequency of the electromagnetic waves is higher than the cutoff frequency of the waveguide 310. Thus, the electromagnetic waves oscillated by the electromagnetic wave oscillator 304 are not cut off but are introduced into the waveguide 310.

Meanwhile, a cutoff wavelength at the waveguide 310 is defined by the following equation 3:

$$\begin{matrix}Equation 3 & \\ {λ}_{c , 10} = \frac{c}{{f}_{c , 10}} = 2 a = 50 cm . & ( 3 )\end{matrix}$$

A wavelength λ_{g} of the waveguide 310 when an oscillation frequency at the electromagnetic wave oscillator 304 is 915 MHz is defined by the following equation 4:

Equation 4

λ_{g}=λ/[1−(f_{c}/f)²]^{1/2}=32.8/[1−(0.6/0.915)²]^{1/2}=43.5 cm (4).

When the discharge tube 312 is inserted spaced apart from an end of the waveguide 310 by ¼ of the wavelength λ_{g} in the waveguide 310, a position in which the discharge tube 312 is inserted, is about 11 cm (≈43.5/4) from the end of the waveguide 310.

As illustrated in FIG. 3, the above-described power unit 302, the electromagnetic wave oscillator 304, the circulatory system 306, the tuner 308, and the waveguide 310 constitute an electromagnetic wave supply unit 322 in the present invention, and the electromagnetic wave supply unit 322 generates electromagnetic waves and supplies the electromagnetic waves to the discharge tube 312.

The discharge tube 312 generates plasma from the electromagnetic waves supplied by the electromagnetic wave supply unit 322 and a mixture gas including steam and oxygen, and gasifies solid coal using the generated plasma so as to generate a synthesis gas. The synthesis gas is mainly composed of carbon monoxide (CO) and hydrogen (H₂) and includes an impurity, such as sulfur compounds, in addition to CO and H₂.

As described above, the mixture gas injected into the discharge tube 312 stabilizes the generated plasma and forms a swirl in the discharge tube 312 so as to protect inner walls of the discharge tube 312 from a high-temperature plasma flame. In general, it is very difficult to generate plasma using only pure steam in an atmospheric state, and even when plasma is generated, plasma may be easily extinguished. Thus, in the present invention, the mixture gas is composed by adding oxygen or air to pure steam that is a base so that plasma can be more stably generated in comparison with a case that pure steam is used.

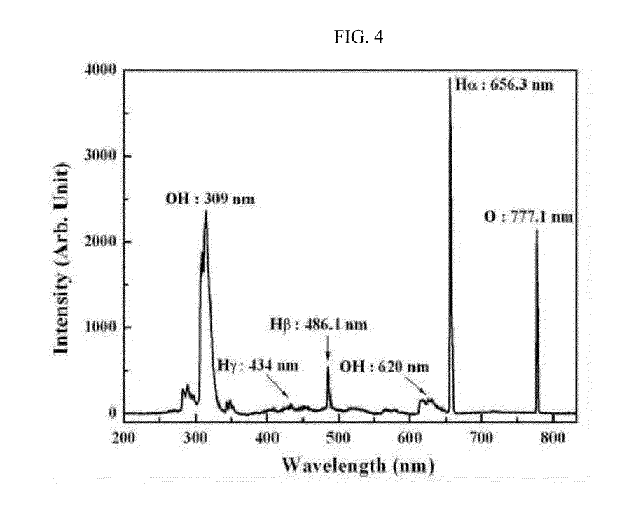

In addition, it is also possible to control a constituent ratio of the synthesis gas generated by controlling a mixture ratio of steam (H₂O) and oxygen (O₂) in the mixture gas. FIG. 4 illustrates an optical emission spectrum obtained from an electromagnetic wave plasma torch using only pure steam (H₂O). As illustrated in FIG. 4, pure steam (H₂O) plasma generates OH, H, and O, and dominant species are OH and H. Thus, it can be predicted that, when coal is gasified from pure steam plasma, the generation quantity of hydrogen is larger than the generation quantity of carbon monoxide (CO) from a reaction of coal and steam plasma. However, when coal is gasified from the mixture gas of steam and oxygen, a mole fraction % of oxygen increases gradually from 0 to 100, in the above drawing, the generation quantity of oxygen atoms having wavelengths of 777 nm and 844.5 nm increases compared to the quantity of hydrogen atoms generated from steam. Thus, as a mixture ratio of oxygen increased, the generation quantity of carbon monoxide (CO) is larger than that of hydrogen. Thus, by controlling the mixture ratio of steam and oxygen, a composition of the synthesis gas can be changed from coal gasification.

The following reaction occurs in the discharge tube 312 by the plasma.

(1) Combustion by oxygen (oxidation reaction): C+O₂→CO₂

The present reaction is a heat dissipation reaction and occurs very fast. Through this reaction, heat required for gasification can be supplied.

(2) Gasification by oxygen (partial oxidation reaction): C+½O₂→CO

The present reaction is also a heat dissipation reaction and occurs very fast.

(3) Gasification by carbon dioxide (CO₂) (Boudouard reaction): C+CO₂→2CO

The present reaction is a heat absorption reaction and is slower than the oxidation reaction.

(4) Gasification by steam: C+H₂O→CO+H₂

The present reaction is a heat absorption reaction and is slower than the oxidation reaction. This reaction is preferred at a high temperature and under a low pressure.

(5) Gasification by hydrogen: C+2H₂→CH₄

The present reaction is a heat dissipation reaction and is slower than the oxidation reaction. However, in case of a high pressure, exceptionally, the speed of this reaction increases.

(6) Water gas shift (WGS) reaction (Dussan reaction): CO+H₂O→H₂+CO₂

The present reaction is slightly a heat absorption reaction and occurs fast. A ratio of CO to H₂ of the synthesis gas is affected by the present reaction.

(7) Methane generation reaction: CO+3H₂→CH₄+H₂O

The present reaction is a heat dissipation reaction and occurs very slowly.

Next, the gas supply unit 314 injects the mixture gas into the discharge tube 312 in the form of a swirl, and the coal supply unit 316 supplies solid coal (pulverized coal) to the plasma generated in the discharge tube 312. Detailed configurations of the gas supply unit 314 and the coal supply unit 316 will be described below.

The ignition unit 318 includes a pair of electrodes disposed in the discharge tube 312 and supplies initial electrons for generating plasma through the pair of electrodes.

The gas discharge unit 320 is provided at an upper end of the discharge tube 312 and discharges the synthesis gas generated by the plasma to the outside. The synthesis gas discharged by the gas discharge unit 320 is purified by the impurity removing unit 104, is stored in the gas storage tank 106, and then is supplied to the gas engine 108.

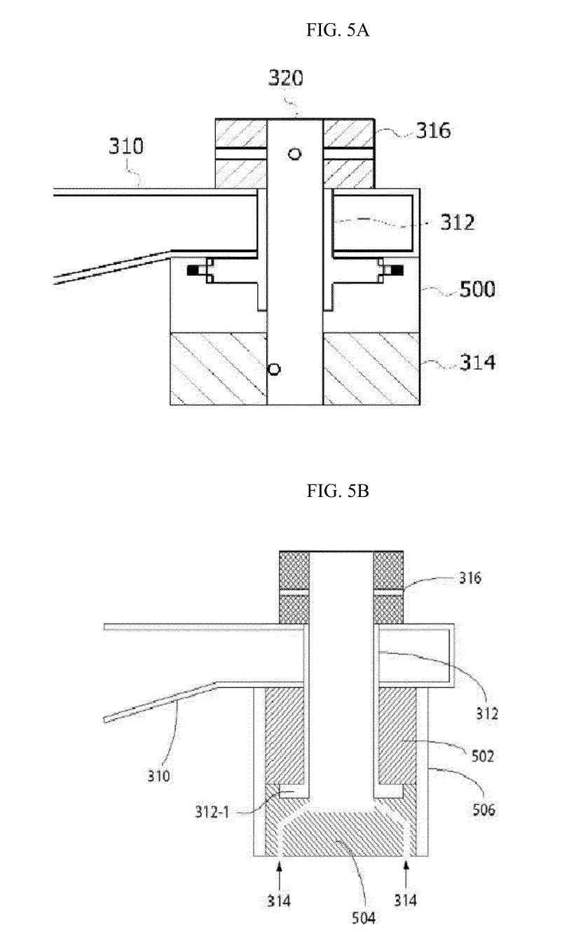

FIGS. 5A and 5B are longitudinal cross-sectional views illustrating a portion in which a waveguide 310 and a discharge tube 312 are connected to each other, of the plasma generator 300 illustrated in FIG. 3.

First, as illustrated in FIG. 5A, the discharge tube 312 is connected to the waveguide 310 and provides a space in which plasma is generated, by electromagnetic waves input through the waveguide 310. The discharge tube 312 may be formed in a cylindrical shape and may be installed to pass through the waveguide 310 in a vertical direction between ⅛ and ½ of a wavelength in the waveguide 310 from an end of the waveguide 310, preferably, in a position that corresponds to ¼ of the wavelength. The discharge tube 312 may be formed of quartz, alumina, or ceramic so that the electromagnetic waves can easily transmit the discharge tube 312. A discharge tube holder 500 formed under the waveguide 310 supports the discharge tube 312 in such a way that the discharge tube 312 is stably inserted into the waveguide 310 and is fixed thereto.

The gas supply unit 314 is formed to surround the discharge tube 312 from a lower end of the discharge tube 312, and the coal supply unit 316 is formed to surround an upper end of the gas supply unit 314, i.e., a portion of the discharge tube 312 in which plasma is formed.

In FIG. 5B, a shape in which the discharge tube 312 and the waveguide 310 are connected to each other, is the same as that of FIG. 5A. However, there is a difference between FIGS. 5B and 5A in that a hanging jaw 312-1 that protrudes outward is additionally provided at the lower end of the discharge tube 312 so as to easily fix the discharge tube 312 and simultaneously to suppress gas effluence. The hanging jaw 312-1 is inserted between a first carbon block 502 and a second carbon block 504 and is supported by the first carbon block 502 and the second carbon block 504. A case 506 is formed outside the first carbon block 502 and the second carbon block 504 so that the discharge tube 312 can be fixed by the case 506. In the present embodiment, the gas supply unit 314 is formed at the second carbon block 504 and supplies gas to the lower end of the discharge tube 312.

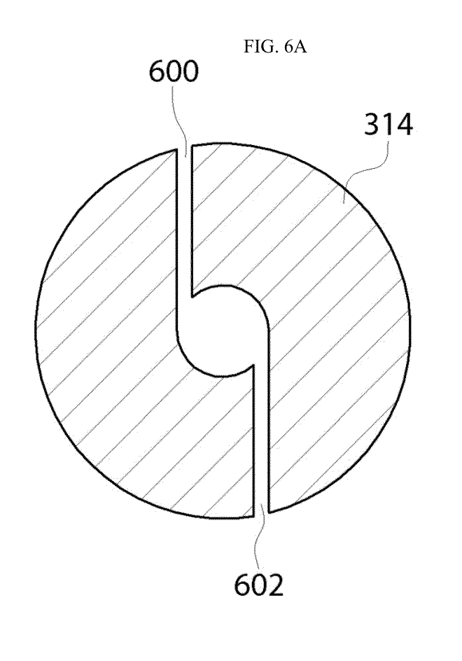

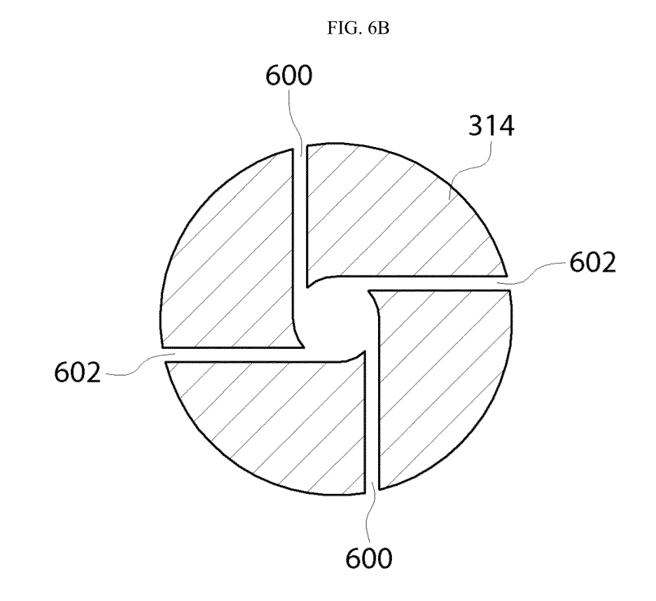

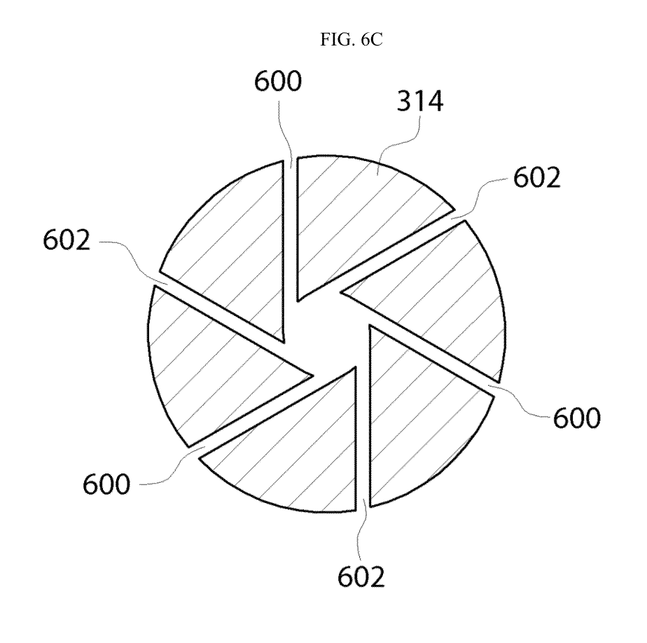

FIGS. 6A through 6C are latitudinal cross-sectional views illustrating a detailed configuration of a gas supply unit 314 of the plasma generator 300 of FIG. 3, according to an exemplary embodiment of the present invention.

As illustrated in FIGS. 6A through 6C, the gas supply unit 314 of the plasma generator 300 according to an exemplary embodiment of the present invention includes at least one steam supply tube 600 and at least one oxygen supply tube 602. The steam supply tube 600 and the oxygen supply tube 602 are configured in such a way that one end of the steam supply tube 600 and one end of the oxygen supply tube 602 are connected to an inside of the discharge tube 312 and the steam supply tube 600 and the oxygen supply tube 602 supply steam and oxygen (or air including oxygen) into the discharge tube 312. Steam and oxygen supplied to each of the steam supply tube 600 and the oxygen supply tube 602 are mixed in the discharge tube 312 and constitute a mixture gas of steam and oxygen.

The steam supply tube 600 and the oxygen supply tube 602 may be formed in the gas supply unit 314 in appropriate numbers as needed. FIG. 6A illustrates an embodiment in which one steam supply tube 600 and one oxygen supply tube 602 are formed, and FIGS. 6B and 6C illustrate an embodiment in which two or three steam supply tubes 600 and two or three oxygen supply tubes 602 are installed. As illustrated in FIGS. 6A, 6B, and 6C, the same numbers of the steam supply tube 600 and the oxygen supply tube 602 may be provided in the gas supply unit 314. That is, when two steam supply tubes 600 are formed, two oxygen supply tubes 602 may also be formed. Also, a predetermined number of steam supply tubes 600 and a predetermined number of oxygen supply tubes 602 may be arranged in the gas supply unit 314 around the discharge tube 312 at the same intervals. As illustrated in FIGS. 6A, 6B, and 6C, the steam supply tube 600 and the oxygen supply tube 602 may be alternately arranged in the gas supply unit 314 (i.e., in the order of the steam supply tube 600, the oxygen supply tube 602, the steam supply tube 600, the oxygen supply tube 602, . . . )

The steam supply tube 600 and the oxygen supply tube 602 are supplied to the discharge tube 312 so that the mixture gas of supplied steam and oxygen rotates along an inner circumferential surface of the discharge tube 312 in the form of a swirl. To this end, as illustrated in FIGS. 6A, 6B, and 6C, the steam supply tube 600 and the oxygen supply tube 602 are connected to the inside of the discharge tube 312 so that steam and oxygen discharged into the discharge tube 312 are discharged along the inner circumferential surface of the discharge tube 312, i.e., in parallel to the inner circumferential surface of the discharge tube 312. To this end, the steam supply tube 600 and the oxygen supply tube 602 need to be configured so that proceeding directions of the steam supply tube 600 and the oxygen supply tube 602 are parallel to the inner circumferential surface of the discharge tube 312 at an end in which the steam supply tube 600 and the oxygen supply tube 602 are connected to the discharge tube 312. In this configuration, supplied steam and oxygen are mixed with each other in the discharge tube 312, rotate in one direction, and have the form of a swirl. Also, rotation directions of supplied steam and oxygen are the same in the steam supply tube 600 and the oxygen supply tube 602.

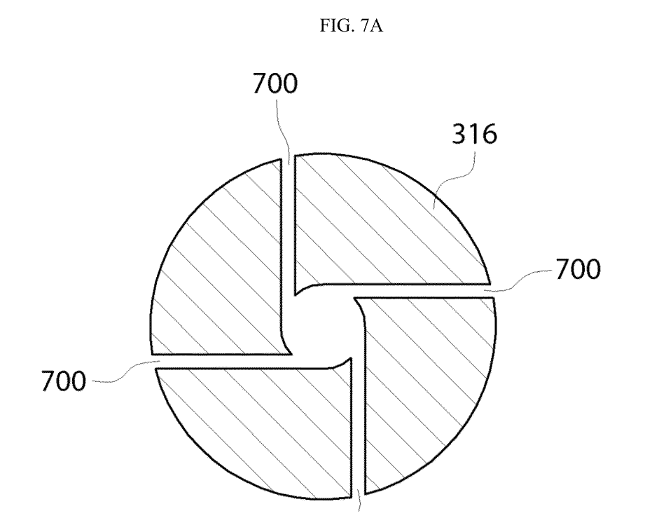

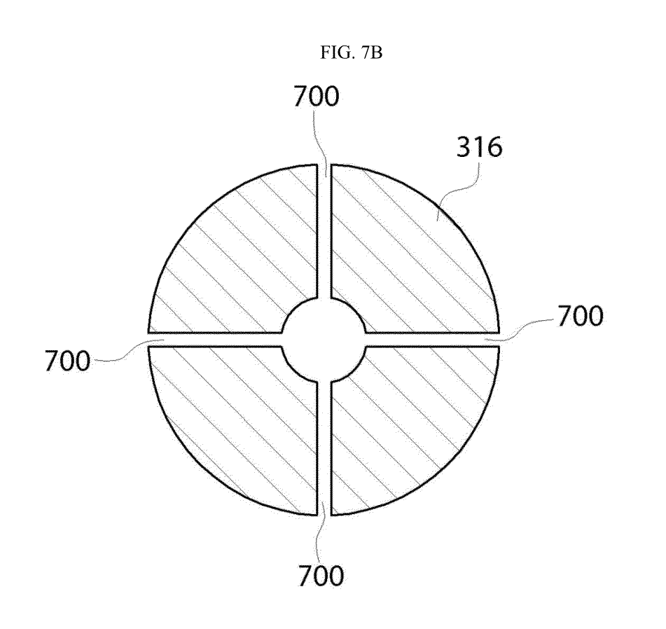

FIGS. 7A and 7B are latitudinal cross-sectional views illustrating a detailed configuration of a coal supply unit 316 of the plasma generator 300 of FIG. 3, according to an exemplary embodiment of the present invention.

As illustrated in FIGS. 7A and 7B, the coal supply unit 316 of the plasma generator 300 according to an exemplary embodiment of the present invention includes at least one coal supply tube 700 and supplies powdery coal (pulverized coal) to the plasma generated in the discharge tube 312 through the coal supply tube 700.

The coal supply tube 700 may be formed in the coal supply unit 316 in an appropriate number as needed, and like in the steam supply tube 600 and the oxygen supply tube 602, a predetermined number of coal supply tubes 700 may be arranged in the coal supply unit 316 around the discharge tube 312 at the same intervals.

In an embodiment of the present invention, the coal supply tube 700 may be supplied to the discharge tube 312 so that supplied powdery coal rotates along the inner circumferential surface of the discharge tube 312 in the form of a swirl. To this end, as illustrated in FIG. 7A, the coal supply tube 700 is connected to the inside of the discharge tube 312 so that coal discharged into the discharge tube 312 is discharged along the inner circumferential surface of the discharge tube 312, i.e., in parallel to the inner circumferential surface of the discharge tube 312. To this end, like in the steam supply tube 600 and the oxygen supply tube 602, the coal supply tube 700 is also configured so that a proceeding direction of the coal supply tube 700 is parallel to the inner circumferential surface of the discharge tube 312 at an end in which the coal supply tube 700 is connected to the discharge tube 312. In this configuration, supplied coal rotates in the discharge tube 312 in one direction and has the form of a swirl. In this case, a rotation direction of the swirl may coincide with the rotation direction of the mixture gas of steam and oxygen.

In another embodiment of FIG. 7B, the coal supply tube 700 may be formed to be directed to the center of plasma formed in the discharge tube 312. In this case, pulverized coal supplied through the coal supply tube 700 is directly sprayed into the center of plasma with a high temperature so that partial combustion and gasification of coal can be more easily performed.

Carbon dioxide (CO₂) may be used as a carrier gas for supplying coal (pulverized coal) into the discharge tube 312. The synthesis gas generated in the plasma generator 300 according to the present invention includes a considerable amount of carbon dioxide (CO₂) in addition to hydrogen (H₂) and carbon monoxide (CO). Thus, when CO₂ is separated from the synthesis gas and is reused as the carrier gas for transferring coal, coal can be efficiently transferred to plasma in the discharge tube 312 and simultaneously, environment pollution caused by emission of CO₂ in the air can also be prevented. In addition, the mixture gas of oxygen and steam may be used as the carrier gas, like in the gas supply unit 314, and pure steam or oxygen may also be used as the carrier gas.

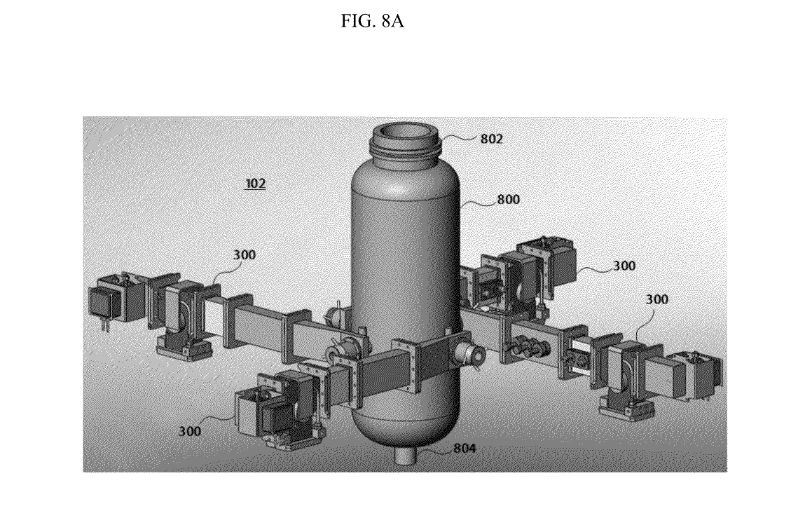

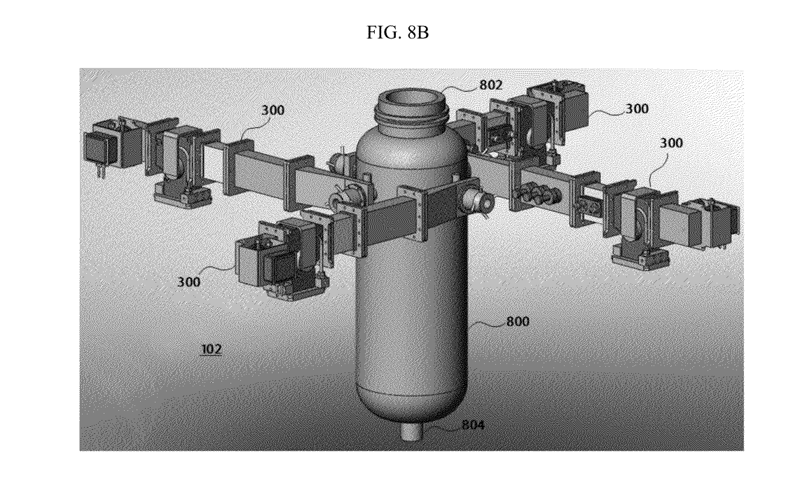

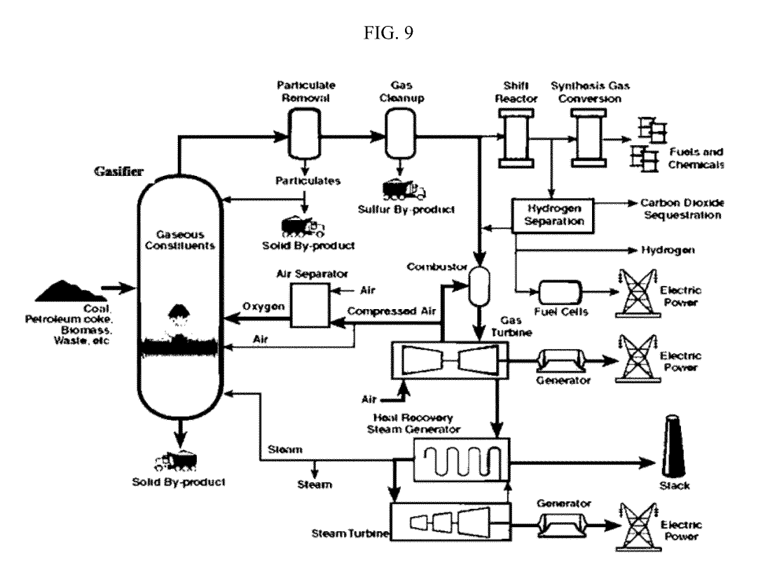

FIG. 8A illustrates a plasma gasifier 102 including at least one plasma generator 300, according to an exemplary embodiment of the present invention. The plasma gasifier 102 according to an exemplary embodiment of the present invention includes at least one plasma generator 300 and a gasification reactor 800 in which a synthesis gas is generated by plasma generated by the plasma generator 300. As illustrated in FIG. 8A, at least one plasma generator 300 is placed in the vicinity of the cylindrical gasification reactor 800, and each plasma generator 300 is combined with the gasification reactor 800 so that the gas discharge unit 320 can be connected to an inside of the gasification reactor 800. The synthesis gas generated by the plasma generated by each plasma generator 300 is concentrated on a synthesis gas outlet 802 at an upper end of the gasification reactor 800, and a by-product generated in this procedure is discharged to a by-product outlet at a lower end of the gasification reactor 800.

FIG. 8B illustrates a plasma gasifier 102 including at least one plasma generator 300, according to another exemplary embodiment of the present invention. Like in FIG. 8A, the plasma gasifier 102 according to another exemplary embodiment of the present invention includes at least one plasma generator 300, a gasification reactor 800, a synthesis gas outlet 802, and a by-product outlet 804. All configurations of FIG. 8B are the same as the plasma gasifier 102 illustrated in FIG. 8A except that the plasma generator 300 is placed at an upper end (not a lower end) of the gasification reactor 800.

While the invention has been shown and described with reference to certain exemplary embodiments thereof, it will be understood by those skilled in the art that various changes in form and details may be made therein without departing from the spirit.

Therefore, the claim scope of the present invention should not be limited to the exemplary embodiments disclosed, and should be defined by the appended claims and equivalents thereof.

1. A generation system comprising:
a plasma gasifier that combusts pulverized coal or biomass using plasma so as to generate a synthesis gas including hydrogen (H₂) and carbon monoxide (CO);
an impurity removing device that removes an impurity included in the generated synthesis gas;
a gas storage tank in which the synthesis gas, an impurity of which has been removed by the impurity removing device, is stored; and
either a gas engine that combusts the synthesis gas stored in the gas storage tank so as to produce electricity or a solid oxide fuel cell (SOFC) that produces electricity using the synthesis gas stored in the gas storage tank.

2. The generation system of claim 1, comprising the solid oxide fuel cell.

3. The generation system of claim 1, wherein the impurity removing device comprises:
a dust removing unit that removes dust included in the synthesis gas; and
a sulfur compound removing unit that removes sulfur compounds included in the synthesis gas.

4. The generation system of claim 21, wherein, when an initial operation of the generation system is performed, the gas engine is configured to combust the synthesis gas that has been stored in advance in the gas storage tank so as to produce electricity and to operate the plasma gasifier using part of produced electricity.

5. The generation system of claim 21, further comprising a steam turbine that produces electricity using at least one selected from the group consisting of heat generated in the plasma gasifier, heat generated from the synthesis gas generated by the plasma gasifier, and heat generated in the gas engine.

6. The generation system of claim 2, wherein, when an initial operation of the generation system is performed, the SOFC is configured to produce electricity using the synthesis gas that has been stored in advance in the gas storage tank and to operate the plasma gasifier using part of produced electricity.

7. The generation system of claim 2, further comprising a steam turbine that produces electricity using heat generated in the plasma gasifier or heat generated from the synthesis gas generated by the plasma gasifier.

8. The generation system of claim 1, wherein the plasma gasifier comprises at least one plasma generator, and the at least one plasma generator comprises:
an electromagnetic wave supply unit that oscillates electromagnetic waves having a predetermined frequency;
a discharge tube in which plasma is generated from the electromagnetic waves supplied by the electromagnetic wave supply unit and a mixture gas of steam and oxygen;
a gas supply unit that injects the mixture gas of steam and oxygen into the discharge tube in a form of a swirl;
a coal supply unit that supplies solid coal to the plasma generated in the discharge tube;
an ignition unit that supplies initial electrons for generating plasma in the discharge tube; and
a gas discharge unit that discharges the synthesis gas synthesized from a reaction of the plasma generated in the discharge tube and coal.

9. The generation system of claim 8, wherein the electromagnetic waves oscillated by the electromagnetic wave supply unit are configured to have a frequency range of 902 to 928 MHz or 886 to 896 MHz.

10. The generation system of claim 8, wherein the gas supply unit is formed to surround the discharge tube from a lower end of the discharge tube and comprises:
at least one steam supply tube having one end connected to an inside of the discharge tube and supplying steam into the discharge tube; and
at least one oxygen supply tube having one end connected to the inside of the discharge tube and supplying oxygen into the discharge tube.

11. The generation system of claim 10, wherein the gas supply unit comprises same numbers of steam supply tubes and oxygen supply tubes arranged in the gas supply unit at the same intervals.

12. (canceled)

13. The generation system of claim 10, wherein the at least one steam supply tube and the at least one oxygen supply tube are alternately arranged in the gas supply unit.

14. The generation system of claim 10, wherein the at least one steam supply tube and the at least one oxygen supply tube are configured in such a way that the at least one steam supply tube and the at least one oxygen supply tube are connected to the inside of the discharge tube so that steam and oxygen discharged into the discharge tube are discharged in parallel to an inner circumferential surface of the discharge tube and steam and oxygen supplied into the discharge tube are mixed with each other and form a swirl.

15. The generation system of claim 8, wherein the coal supply unit is formed to surround the discharge tube at an upper end of the gas supply unit and comprises at least one coal supply tube having one end connected to the inside of the discharge tube and supplying solid coal to the plasma generated in the discharge tube.

16. The generation system of claim 15, wherein the at least one coal supply tube is arranged in the coal supply unit at same intervals.

17. The generation system of claim 15, wherein the at least one coal supply tube is configured to have one end connected to the inside of the discharge tube being formed to be directed to a center of plasma generated in the discharge tube so that coal supplied through the coal supply tube is able to be sprayed to the center of the plasma.

18. The generation system of claim 15, wherein the at least one coal supply tube is configured to be connected to the inside of the discharge tube so that coal discharged into the discharge tube is discharged in parallel to the inner circumferential surface of the discharge tube so that coal discharged into the discharge tube is able to form a swirl.

19. The generation system of claim 18, wherein the at least one coal supply tube is disposed in the coal supply unit so that discharged coal is able to form a swirl in the same direction with the mixture gas of steam and oxygen supplied by the gas supply unit.

20. The generation system of claim 8, wherein the coal supply unit mixes coal with at least one gas selected from the group consisting of steam, oxygen, a mixture gas of steam and oxygen, and carbon dioxide (CO₂) and supplies coal into the discharge tube.

21. The generation system of claim 1, comprising the gas engine.
